(19) United States
(12) Patent Application Publication
(10) Pub. No.: US 2010/0243475 A1
(43) Pub. Date: Sep. 30, 2010

(54) Electrochemical Hydrogen Reclamation System

(75) Inventors: Glenn A. Eisman, Niskayuna, NY (US); Michael D. Gasda, Palo Alto, CA (US); Daryl Ludlow, Rennselaer, NY (US)

Correspondence Address: H2 PUMP, LLC, 11 NORTHWAY LANE NORTH, LATHAM, NY, 12110, US

(73) Assignee: H2 Pump LLC, Latham, NY (US)

(21) Appl. No.: 12/732,013

(22) Filed: Mar. 25, 2010

Related U.S. Application Data
(60) Provisional application No. 61/164,093, filed on Mar. 27, 2009.

(51) Int. Cl. B01D 53/32; C25B 9/08; B01D 53/22; B01D 71/02

(52) U.S. Cl. 205/763; 204/252; 204/264

(57) ABSTRACT

A hydrogen reclamation system comprises a first hydrogen separator having an inlet and an outlet and a second hydrogen separator having an inlet and an outlet wherein an inlet gas stream having a first concentration of hydrogen gas enters said first hydrogen separator inlet and is processed into an outlet gas stream having a second concentration of hydrogen gas which exits said first hydrogen separator outlet and subsequent to exiting said first hydrogen separator outlet, said outlet gas stream enters said second hydrogen separator inlet and is processed into a second outlet gas stream having a third concentration of hydrogen gas which exits said second hydrogen separator outlet.

### REFERENCE TO RELATED APPLICATIONS

This application claims priority to U.S. Provisional Patent Application No. 61/164,093, filed Mar. 27, 2009. The content of this application is incorporated herein by reference in its entirety.

### FIELD OF THE INVENTION

The present invention relates to apparatus, methods and applications for electrochemical cells. Electrochemical cells using various ion exchange membranes may be used.

### BACKGROUND

Electrochemical technologies are used in a variety of industrial applications, due in part to processes which require the transport of an ion from one compartment or chamber to another, thereby controlling the chemistry of that specific process. In many cases it has a positive efficiency and environmental impact over other methods and technologies.

A variety of electrochemical technologies are known, wherein electrical power is applied to a cell or a series of cells in order to impart a chemical reaction. Two examples of which include the industrial production of caustic soda via the chlor-alkali process (sodium hydroxide, chlorine, and hydrogen), and water electrolysis whereby oxygen and hydrogen are generated for a variety of applications. In the chlor-alkali electrochemical processes, brine and water are electrolyzed to form sodium ions and hydroxyl ions in the anode and cathode respectively. The sodium ion is driven through the ion exchange membrane to from caustic soda (NaOH), an industrial chemical. In the water electrolysis process, water is electrolyzed to oxygen molecules and the protons are driven through the ion exchange membrane resulting in the formation of gaseous hydrogen. Both processes are well known and established. In each process, an ion is driven through the ion exchange membrane by the applied electric field in contact with a catalyst layer. Galvanic electrolysis cells are also known and are distinguished from the electrolysis process whereby a reacting fuel such as hydrogen comes in contact with a catalyst and a proton ion exchange membrane and subsequently driven through the membrane where it reacts with oxygen to form water. Power is generated in this galvanic application in contrast to electrolysis cells where power is added. In both electrolytic and galvanic cells utilizing ion exchange membrane technology, an electrically non-conducting membrane is typically sandwiched between two catalyzed electrodes. One of the electrodes is typically referred to as the anode, the other the cathode. In selected electrolytic cells, the catalyst at the anode can serve to divide hydrogen molecules into their respective protons and electrons. Each hydrogen molecule produces two protons which pass through the membrane to the other electrode, typically referred to as the cathode. The protons at the cathode can react with other gases or liquids to form other molecules as desired by the process. The electrons generated at the catalyst at the anode travel through an electrically conductive path around the membrane. In electrolysis cells this is accomplished by an applied electric field from a power supply. The electrons then are fed to the cathode where the desired chemistry takes place.

In addition to synthesizing new chemicals, in one specific case, an electrochemical process can also be used to selectively transfer (or “pump”) hydrogen from one side of the cell to another. For example, in a cell utilizing a proton exchange membrane, the membrane is sandwiched between a first electrode and a second electrode, a gas containing hydrogen is placed at the first electrode, and an electric potential is placed between the first and second electrodes, the potential at the first electrode with respect to ground (or “zero”) being greater than the potential at the second electrode with respect to ground. Each hydrogen molecule reacted at the first electrode produces two protons which pass through the membrane to the second electrode of the cell, where they are rejoined by two electrons to form a hydrogen molecule (sometimes referred to as “evolving hydrogen” at the electrode). In this example, molecular hydrogen is oxidized to protons and electrons at the anode and then electrochemically reduced at the cathode to recombine the protons into molecular hydrogen.

Electrochemical cells used in this manner are sometimes referred to as hydrogen electrolysis or hydrogen pumps. In addition to providing controlled transfer of hydrogen across the cell, hydrogen pumps may also be used to separate hydrogen from gas mixtures containing other components, components which are not impacted by the electrolysis process. Where the hydrogen is electrochemically pumped into a confined space, such cells can be used to compress the hydrogen, at very high pressures in some cases.

There is a continuing need for apparatus, methods and applications relating to electrochemical cells.

### BRIEF SUMMARY OF EMBODIMENTS OF THE INVENTION

According to various embodiments of the invention, a hydrogen reclamation system is configured to include first and second hydrogen separation devices. An inlet gas stream containing hydrogen gas as well as other constituents enters the first hydrogen separator and is processed thereby outputting a waste gas stream, and a hydrogen gas stream having a higher purity level than the inlet stream. In order to further purify the hydrogen gas stream the system contains a second hydrogen separation device, which can comprise a palladium hydrogen separator or any separation device, including passive membranes or temperature or pressure swing adsorption methods. The output hydrogen gas stream then enters the second hydrogen separator and is processed thereby outputting a waste gas stream, and a hydrogen gas stream having a higher purity level than the inlet stream. The resultant hydrogen gas stream is of a higher purity and suitable for a variety of applications.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

The figures are not intended to be exhaustive or to limit the invention to the precise form disclosed. It should be understood that the invention can be practiced with modification and alteration, and that the invention be limited only by the claims and the equivalents thereof.

FIG. 1A illustrates an electrochemical hydrogen reclamation system implemented in accordance with an embodiment of the invention.

FIG. 1B illustrates an electrochemical hydrogen reclamation system implemented in accordance with an embodiment of the invention.

FIG. 1C illustrates an electrochemical hydrogen reclamation system implemented in accordance with an embodiment of the invention.

FIG. 2A illustrates an electrochemical hydrogen reclamation system implemented in accordance with an embodiment of the invention.

FIG. 2B illustrates an electrochemical hydrogen reclamation system implemented in accordance with an embodiment of the invention.

FIG. 2C illustrates an electrochemical hydrogen reclamation system implemented in accordance with an embodiment of the invention.

### DETAILED DESCRIPTION OF THE INVENTION

It will be appreciated that the apparatus, methods, and applications of the invention can include any of the features described herein, either alone or in combination.

Embodiments under the present invention generally relate to electrochemical cells utilizing proton exchange membranes. As examples, common membrane materials include Nafion®, Gore Select®, sulphonated fluorocarbon polymers, polybenzimidazole (PBI) membrane, and polyetherether ketone (PEEK) membranes. Other examples of membranes which can be utilized in accordance with this invention include hydrocarbon-based materials, solid proton conductors such as CsH2PO4 or related solid state proton conductors.

Various examples of PBI based electrochemical systems are provided in U.S. Pat. No. 4,814,399, which is hereby incorporated by reference. As a further example, PBI membranes used with the present invention can be prepared by a sol-gel process, as described in the article, High-Temperature Polybenzimidazole Fuel Cell Membranes via a Sol-Gel Process, Chem. Mater. Vol. 17, No. 21, 2005, and in U.S. patent application Ser. No. 11/627,955, or it may be a cast membrane, as identified by U.S. Pat. No. 5,525,436 which are each incorporated herein by reference.

An electrochemical cell can be operated in a pumping mode by placing an electrical potential across the electrodes. The first electrode, generally referred to as the anode, has a higher electric potential with respect to zero than the second electrode, which is generally referred to as the cathode. The anode is contacted with hydrogen, which is ionized and subsequently evolved at the cathode as described above. The hydrogen gas can be pure hydrogen, or a mixed gas containing any amount of hydrogen. The hydrogen gas may be referred to synonymously as a source gas, hydrogen source gas, hydrogen containing gas, etc.

The direction of hydrogen “pumping” across the membrane can be controlled according to the polarity of the electrical potential between the first and second electrodes. The hydrogen flows between the electrodes from higher to lower potential with respect to ground or zero. Thus, reversing the polarity across the cell can reverse the direction of hydrogen flow between the electrodes. In this context, “reversing a direction” is taken to mean selectively evolving hydrogen at either electrode according to the polarity of the potential that is applied to the cell.

It is noted that the designations of “anode” and “cathode” can be misleading in pumping cells where the polarity is sometimes reversed. Thus, the electrodes are sometimes alternately referred to as “first” and “second.”

The production or reclamation of high purity or dry hydrogen from hydrogen mixed gas usually consists of the pairing of mechanical compression and pressure swing adsorption units (PSA). The mechanical compressor is used to compress the bulk gas, and the PSA unit separates selected impurities from hydrogen through a cyclic adsorption/desorption process Inherent inefficiencies and drawbacks result from combination of these two technologies applied to hydrogen purification including, but not limited to: compression of the entire gas makeup—including non-hydrogen gases, poor hydrogen utilization/low recovery rates, frequent maintenance, high cost, system complexity, and installation complexity. Furthermore, low volume compressors are especially problematic and require excessive amounts of power to operate. An alternative to this approach is electrochemical hydrogen pumping.

Electrochemical hydrogen pumping is well suited for the bulk purification of hydrogen from mixed gases. The process is highly efficient, only pumps hydrogen, is capable of hydrogen compression, does not include moving parts, is scalable, and has a very high turn-down ratio.

Electrochemical hydrogen pumping works through the oxidation of hydrogen and subsequent reduction of protons. Hydrogen gas, pure or impure, enters the anode compartment of the pump and comes in contact with a catalyst, where hydrogen is oxidized to protons and electrons. The protons are driven through a proton conducting, electrically insulating, gas separator by an electric field generated through the electric potential between the anode and cathode catalyst layers. Electrons are driven through an electrical circuit from the anode to the cathode by the power supply. Molecular hydrogen evolves at the cathode catalyst layer with the combination of electrons and protons. The process inherently purifies hydrogen, as only the hydrogen (in proton form) is actively passed through the membrane separator. The magnitude of electrical current is directly proportional to the flow of hydrogen across the pump cell.

This active and selective removal of hydrogen from mixed gas allows for hydrogen pumping and purification with minimal influence on the mixed gas bulk pressure, thus avoiding disruption of up-stream processes. Mechanical compressors may require additional measures to avoid disruption of up-stream processes via the low pressure induced “pull” of the gas from the source by a mechanical compressor.

Unfortunately, a small amount of non-water impurities will passively diffusion and transport across the membrane, thus limiting the level of hydrogen purity from electrochemical hydrogen pumping. Purities as high as four 9's, on a dry basis, have been demonstrated via electrochemical hydrogen pumping. In addition to these impurities, water can easily cross most proton conducting membranes, resulting in output hydrogen of moderate-to-high water contents (2-50%).

While basic electrochemical hydrogen pumping is adequate for many hydrogen product and recycling applications, enhanced purification capability is desired for others. Utilizing the bulk purification properties of electrochemical hydrogen pumping in tandem with the high purity capabilities of palladium hydrogen separators is advantageous.

An alternate method (to PSA technology) for the further purification of hydrogen is the use of palladium separators. Palladium is well known to produce very high purity hydrogen, as only hydrogen is allowed to pass through the palladium membrane. Better than six 9's, and as high as nine 9's, are often reported in the product literature on palladium purifier by suppliers (Hy9, Johnson Matthey). A limitation of palladium purification lays in the need for large hydrogen partial pressure gradients across the palladium membrane. If the bulk mixed gas were to be directly purified via a palladium membrane, even higher bulk gas pressures would be required to supply hydrogen partial pressure gradients for adequate palladium utilization. In this sense, mechanical compression is not well suited for high purity hydrogen purification with palladium separators.

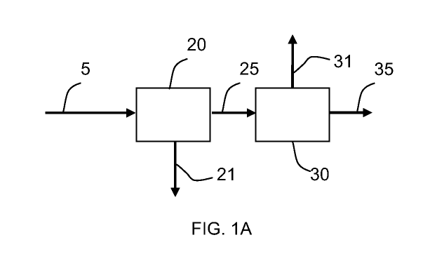

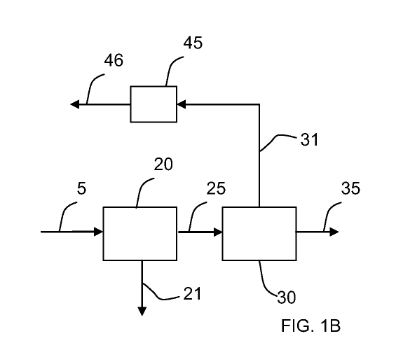

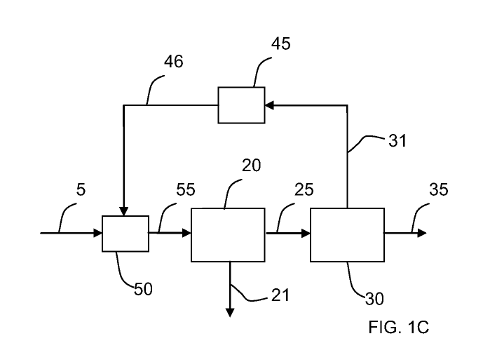

Ideally, the bulk purification, compression, and final “polishing” to produce high purity dry hydrogen with extremely low dew points (less than −50 degrees Centigrade) would be performed efficiently, with minimal impact on up-stream processes, in a single hydrogen purification system. FIG. 1A depicts a preferred embodiment of the invention. The Electrochemical Hydrogen Pump (EHP) 20 receives an inlet gas stream 5 consisting in some portion of hydrogen. Inlet gas stream 5 may be comprised of various constituents including without limitation, carbon dioxide, carbon monoxide, nitrogen, argon, other inert gases, hydrogen cyanide, hydrazine, and other industrial process gases. Hydrogen is electrochemically extracted from inlet gas stream 5 within the EHP 20. A substantially pure hydrogen gas stream 25 exits the EHP 20. A second gas stream 21 exits the EHP 20 and consists of the balance of the input gas stream after hydrogen extraction. The substantially pure hydrogen gas stream 25 enters a palladium separator 30, from which high purity hydrogen 35 and the remaining gases 31 exit in separate gas streams.

Palladium separator 30 may be comprised of layers of a palladium metal foil which are sandwiched by cell separators. For example palladium separator 30 may have inlet and exit ports on the foil side that is fed the impure gas, and an exit port on the high purity side. The impure gas enters the device and under the predetermined specifications, requires an optimum temperature, pressure, and differential hydrogen partial pressure across the metal foil for maximizing the efficiency. The foil may be of any thickness but the thinner the higher the hydrogen flux. Temperatures up to approximately 400-450 degrees Centigrade have been tested, and pressures may be as high as thousands of pounds per square inch. Scaling the unit to larger sizes is also an alternative by adding additional layers of foils.

FIG. 1B shows an alternate configuration in which the flow rate and/or pressure of the hydrogen depleted gas exiting the palladium separator 31 is controlled via a pressure and/or flow regulating device 45. Gas exits regulator 46 at a lower pressure than it enters palladium separator 31.

FIG. 1C shows an alternate configuration in which the low pressure gas 46 is combined with the inlet gas stream 5 via a union device 50. Alternatively, devices 45 and 50 can be one in the same, where a single device could perform both functions (flow/pressure control and gas stream combination). Alternatively, the low pressure gas 46 can be fed directly to the inlet of the EHP 20.

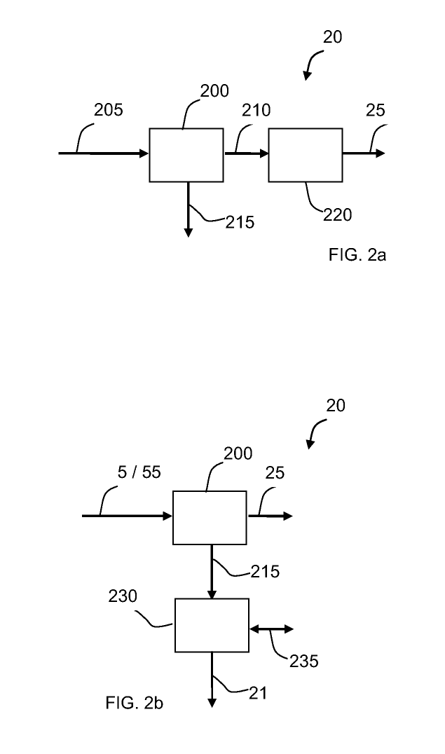

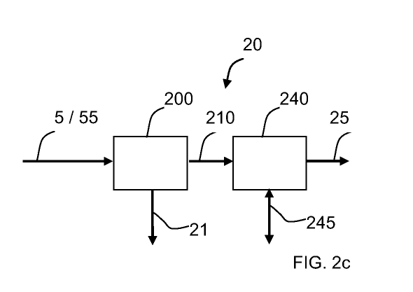

FIG. 2a depicts a scenario in which the EHP 20 includes a gas conditioning device 220 which modifies the output hydrogen gas 210 prior to further processing at the palladium purifier. This device may be used to add or remove components from the gas stream, or to modify physical properties (pressure, temperature).

FIG. 2b depicts a scenario in which the EHP 20 includes a gas conditioning device 230 which modifies the mixed gas exhaust stream 215 to obtain a desired characteristic for further use. The gas would then exit as an altered gas stream 21 with desired characteristics (purity, gas content, temperature, etc.) The gas conditioning device 230 may include a second exit or inlet port to add or remove substances 235 from the gas stream 215.

FIG. 2c depicts a scenario in which the EHP 20 includes a device 240 which can act to redirect the substantially pure hydrogen gas stream 210 to an alternate path 245 for means of protecting the EHP or palladium from undesirable conditions. This device 240 may be capable of adding or subtracting substances 245 to or from the substantially pure gas stream 210.

The electrochemical hydrogen pump 20 extracts hydrogen from the hydrogen containing inlet gas 5 to produce a substantially pure hydrogen stream 25. The inlet gas 5 may contain fractions of a wide range of non-hydrogen gases including, but not limited to, carbon monoxide, carbon dioxide, nitrogen, water vapor, methane, oxygen, and hydrogen sulfide. The hydrogen content of the inlet gas 5 may have a wide range: from trace amounts to 100%.

Hydrogen is electrochemically extracted from the mixed gas at an anode and evolves at a cathode. Gases which are not consumed by the EHP anode exit the device through one port 21, while electrochemically pumped hydrogen exits through a separate port 25. Enough hydrogen enters the device in the gas stream 5 to maintain a stoichiometric ratio greater than one. Excess hydrogen and other gases exiting the EHP anode comprise the waste gas stream 21. The cathode gas stream exiting the EHP cathode 25 may or may not contain a higher fraction of hydrogen than the stream entering the EHP anode 5. The EHP also serves to elevate or drop the hydrogen partial pressure of gas stream 25 with respect to the inlet gas stream 5. Increased hydrogen partial pressure is desired to facilitate increased hydrogen flux through the palladium separator 30. However, allowing the hydrogen partial pressure to decrease from the inlet gas stream 5 to the substantially pure hydrogen stream 25 can aid in the hydrogen pumping process by the pressure induced Nernst voltage.

The EHP 20 can operate within multiple temperature ranges depending on the type of materials within the pump. In particular, the proton conducting materials define the operating temperature window. One class of proton conducting membranes PEM, (also known as polymer electrolyte membranes) may operate from 30° C. to 100° C. under standard conditions. These “low-temperature” materials utilize sulfonic acid sites bound within a polymer structure to facilitate proton conduction. Proper membrane hydration is required to obtain sufficient proton conduction, thus limiting the operating temperature to less than the boiling point of water for the given operating pressure. These materials may operate at increased temperatures with elevated pressure. Another class of materials usually operates from 120° C. to 200° C. These materials typically utilize acids with low vapor pressures as the proton conductor, allowing higher operating temperatures. For instance, phosphoric acid is commonly used and can operate as high as 200° C. depending on the operating temperature. The formation of liquid water is detrimental to such proton conductors (as liquid water can dilute the acid) and, as such, these materials are usually operated above the boiling point of water. In addition, the proton conductivity typically increases with increased temperature, leading to more efficient operation at increased temperatures.

A small fraction of the non-hydrogen gases will permeate through the proton conducting membrane, somewhat reducing the purity of the substantially pure hydrogen output gas 25. Hydrogen is further purified by separation from other gases 25 via the palladium separator 30. The palladium separator consists of a thin palladium membrane (tubular or planar), across which only hydrogen can pass (Johnson Matthey, Hy9). The remaining gases exit with a lower hydrogen fraction than they entered 31. A highly pure hydrogen gas stream 35 exits the palladium separator via a separate port.

A negative hydrogen partial pressure gradient must exist from the inlet to the outlet chambers of the palladium separator to drive hydrogen flow through the palladium membrane. This partial pressure gradient may exist due to an elevated hydrogen partial pressure of the entire EHP hydrogen outlet fluid network 25, 31 due to external influence. The partial pressure gradient may also be induced via an additional device(s) 45, 50. For instance, one (or both) of these devices may be a pressure regulator or orifice/flow restrictor. These devices may be passive or actively controlled. They may be connected in fluid parallel or series.

As hydrogen flows through the inlet chamber of the palladium membrane, the remaining gas decreases in hydrogen content, thus decreasing in hydrogen partial pressure. The result is a decrease in magnitude of the negative hydrogen partial pressure gradient across the palladium membrane and a lower hydrogen flux through the palladium membrane. Excess semi-pure hydrogen gas can be delivered to the palladium separator via increased gas flow to maintain a substantial hydrogen partial pressure gradient. The excess semi-pure hydrogen exhaust gas 31 of the palladium separator can be fed back to the inlet gas stream 5 of the system to be recovered by the EHP. The hydrogen within this return gas can be reprocessed, thus recovering a maximum percentage of hydrogen from the original mixed gas stream 5 while maximizing palladium separator utilization.

Any or all of the gas streams may be altered with additional devices. For instance, the temperature, pressure, velocity, or contents of the substantially pure hydrogen gas stream 25 may be altered prior to entering the palladium separator 30 via another device 220. The addition or extraction of energy from these gas streams may be coupled to other gas streams through similar devices to help improve the overall efficiency of the system.

In the preferred embodiment, the EHP 20 produces substantially purified hydrogen 25 gas from an inlet gas 5 containing some fraction of hydrogen. This substantially pure hydrogen gas 25 is then fed to a palladium separator 30 which further purifies the hydrogen to produce very high purity hydrogen 35. The pure hydrogen output 35 of the palladium separator 30 would have characteristics desirable for further use, including substantial flow and pressure.

The non-hydrogen gas stream exiting the palladium separator 31 is then fed back and combined with the inlet gas 5 to simultaneously facilitate high levels of palladium utilization and hydrogen recovery.

The properties of each gas stream would be managed through active or passive control of additional devices networked together to optimize the conservation of energy while minimizing the addition or removal of substances to or from the system. Such gas stream manipulation may include the transfer of heat energy from the one or both palladium exhaust gases 31, 35 to another gas stream (the palladium inlet gas 25 and/or inlet gas 5) via heat exchanger(s). Unnecessary water within any gas stream may be collected and redirected to other gas streams via combinations of condensers and vaporizers. Such water systems may include the use of filtration devices.

Although palladium membranes can provide substantial benefits for the further purification of hydrogen, other passive hydrogen separation membranes may be used. Various classes of hydrogen separation membrane materials include: size-sieving glassy polymers, transition metals (i.e. palladium and palladium alloys), amorphous silica and zeolite membranes, carbon based membranes (carbon nanotubes). Some of these hydrogen separation membranes are commercially available (e.g., Polysep from Honeywell, PRISM from Monsanto) and some are research grade. The selection of which membrane to use is guided by balancing cost, desired separation properties, and operating characteristics of the separator. What all of these membranes have in common is that hydrogen is driven through the membrane (in various molecular forms: hydrogen molecules, protons, etc.) via a hydrogen partial pressure gradient. As such, the combination of these passive hydrogen separating membranes (for final hydrogen purification) with an electrochemical pump (for pressurization and substantial purification) leverages the strengths of each device. Any hydrogen partial pressure driven separation membrane can be used in conjunction with the electrochemical hydrogen pump in this application.

For example a 45 cm² perfluorosulfonic acid proton exchange membrane and electrode assembly was assembled and operated as an electrochemical hydrogen pump. The membrane and electrode assembly was based on standard perfluorosulfonic acid Proton Exchange Membrane materials, one example of which is Nafion® (E.I. DuPont). The pump module was operated between 0 and 2 amps/cm², which translate to a hydrogen pumping rate of up to approximately 0.7 standard liters per minute. Alternatively for operation at higher flux rates, cell size and the number of cells may be varied to achieve desired results.

The gas phase output of the pump was hydrogen and water, both proportional to the operating point of the pump module and the temperature. Typically the water content of the pumped hydrogen can be at a dew point of up to 60 degrees or greater. The palladium separator of a type manufactured and sold by HY9 Corporation, of Massachusetts, was coupled to the electrochemical hydrogen pump. Operating conditions of the two devices are found in Examples 1 and 2. The illustrated examples demonstrate the operating capability of the “coupled” devices so as to generate a pure hydrogen stream.

### Example 1

Single Cell Nafion Pump - Palladium

| | Pump Module | | Palladium Module | |
|---|---|---|---|---|
| Conditions | Inlet | Outlet | Inlet | Outlet |
| Pressure (psi) | Ambient | 5, 15** | 5, 15 | ambient** |
| Current density | 0-2 amp/cm² | | N/A | N/A |
| (amps/cm²) | | | | |
| H₂ Flux (slm) | 0-~0.64 | | ~0.64 | up to .25 |
| Gas Composition | H₂/H₂O | H₂/H₂O | H₂/H₂O | >99.9999% H₂ |
| Temperature (° C.) | 50-90 | | ~300 | |
| Dew Point (° C.) | ~40 | ~40 | ~40 | −50 to −100 |

**Palladium output pressure and flux are proportional to applied hydrogen partial pressure to the Pd module, water content of the gas, as well as with the temperature and the area of the palladium module.

Palladium output pressure and flux are proportional to applied hydrogen partial pressure to the Pd module, water content of the gas, as well as with the temperature and the area of the palladium module.

An alternative example couples a polybenzimidazole high temperature membrane-based pump to a palladium module. The palladium modules are the same as the above detailed embodiment, however in this example the surface area of the unit is larger. The parameters are presented in this Example 2 are shown below. The example demonstrates the ability to pump hydrogen through the palladium membrane using a polybenzimidazole-based hydrogen pump module.

The pump outlet pressure prior to entering the palladium separator is a specific case only in this example. It can be increased or decreased as dictated by the relative sizes of the two modules, flux rates, etc. In this example hydrogen is fed to the palladium module at very low volumetric flows. Increasing the pressure, temperature, volume, etc., can increase the flux rate and palladium module pressure.

### Example 2

Polybenzimidazole - Palladium

| | Pump Module | | Palladium Module | |
|---|---|---|---|---|
| Conditions | Inlet | Outlet | Inlet | Outlet |
| Pressure (psig) | Ambient | 7 | 7 | ambient** |
| Current density | 0-0.5 amp/cm² | | n/a | n/a |
| (amps/cm²) | | | | |
| H₂ Flux (slm) | 0-~19 | | 0-~19 | 2-4* |
| Gas Composition | H₂/H₂O⁺ | H₂/H₂O | H₂/H₂O | >99.9999% H₂ |
| Temperature (° C.) | 160-180 | | 300-400 | |
| Dew Point (° C.) | <−50 | ~50 | ~50 | −50 to −100 |

⁺Includes impurities such as ammonia and carbon monoxide
**Palladium output pressure and flux are proportional to applied hydrogen partial pressure to the Pd module, water content of the gas, as well as with the temperature and the area of the palladium module.

Another embodiment of this invention relates to the use of a device to minimize phosphoric acid entering the palladium module from a phosphoric acid hydrogen pump module, e.g., from a polybenzimidazole pump module. In this specific example, an acid trap is placed between the two devices.

Discussion in the present case is generally made with respect to particular aspects of electrochemical cell technologies affected by the concepts reflected in the claims. Basic construction and operating techniques for electrochemical cells are well known in the art. As examples, various suitable designs and operating methods that can be used as a base to implement the present invention are described in the teachings of U.S. Pat. Nos. 4,620,914; 6,280,865; 7,132,182 and published U.S. patent application Ser. No. 10/478,852, which are each hereby incorporated by reference in their entirety.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A hydrogen reclamation system, comprising:
a first hydrogen separator having an inlet and an outlet;
a second hydrogen separator having an inlet and an outlet;
wherein an inlet gas stream having a first concentration of hydrogen gas enters said first hydrogen separator inlet and is processed into an outlet gas stream having a second concentration of hydrogen gas which exits said first hydrogen separator outlet;
wherein subsequent to exiting said first hydrogen separator outlet, said outlet gas stream enters said second hydrogen separator inlet and is processed into a second outlet gas stream having a third concentration of hydrogen gas which exits said second hydrogen separator outlet.

2. The hydrogen reclamation system of claim 1, wherein said first hydrogen separator is an electrochemical hydrogen separator.

3. The hydrogen reclamation system of claim 2, wherein said second hydrogen separator is a palladium hydrogen separator.

4. The hydrogen reclamation system of claim 1, wherein said first concentration of hydrogen gas is lower than said second concentration of hydrogen gas.

5. The hydrogen reclamation system of claim 4, wherein said second concentration of hydrogen gas is lower than said third concentration of hydrogen gas.

6. The hydrogen reclamation system of claim 5, wherein said third concentration of hydrogen gas is at least 99.5%.

7. A method for the reclamation of hydrogen, comprising:
providing a first hydrogen separator having an inlet and an outlet;
providing a second hydrogen separator having an inlet and an outlet;
wherein said first hydrogen separator is configured to process an inlet gas stream having a first concentration of hydrogen gas and output an outlet gas stream having a second concentration of hydrogen gas which exits said first hydrogen separator outlet;
wherein subsequent to exiting said first hydrogen separator outlet, said outlet gas stream enters said second hydrogen separator inlet and is processed into a second outlet gas stream having a third concentration of hydrogen gas which exits said second hydrogen separator outlet.

8. The method for the reclamation of hydrogen of claim 4, wherein said first hydrogen separator is an electrochemical hydrogen separator.

9. The method for the reclamation of hydrogen of claim 5, wherein said second hydrogen separator is a palladium hydrogen separator.

10. A hydrogen reclamation system, comprising:
a first hydrogen separator having an inlet and an outlet;
a second hydrogen separator having an inlet and an outlet;
wherein an inlet gas stream having a first humidity level enters said first hydrogen separator inlet and is processed into an outlet gas stream having a second humidity level which exits said first hydrogen separator outlet;
wherein subsequent to exiting said first hydrogen separator outlet, said outlet gas stream enters said second hydrogen separator inlet and is processed into a second outlet gas stream having a third humidity level which exits said second hydrogen separator outlet.

11. The hydrogen reclamation system of claim 10, wherein said third humidity level has a dew point of less than −50 degrees centigrade.
